(19) United States
(12) Patent Application Publication
(10) Pub. No.: US 2004/0194369 A1
(43) Pub. Date: Oct. 7, 2004

(54) Magnetic ground cover

(76) Inventor: Jon B. Schneider, Marietta, OH (US)

Correspondence Address: Law Offices of Jerome J. Norris, Suite 305, 1901 Pennsylvania Avenue, N.W., Washington, DC, 20006, US

(21) Appl. No.: 10/750,913

(22) Filed: Jan. 5, 2004

Related U.S. Application Data
(60) Provisional application No. 60/459,266, filed on Apr. 2, 2003.

(51) Int. Cl. A01G 7/00

(52) U.S. Cl. 47/9

(57) ABSTRACT

A self-coherent particulate magnetic mulch to protect selected ground areas from erosion by wind and/or rain and suppress the growth of undesired vegetation. The mulch is composed of magnetic particles having a rough diameter ranging from about 1 millimeter to about 25 millimeters, preferably from about 6 millimeters to about 13 millimeters. A protective ground cover is formed by applying the particulate magnetic mulch to the area to be protected at a suitable thickness.

The invention relates to protective ground covers having a magnetic property and materials suitable therefor used as mulch materials, and claims benefit of the Apr. 2, 2003 filing date of provisional application P60/459,266.

### BACKGROUND OF THE INVENTION

1. Field of the Invention

2. Brief Description of the Prior Art

Mulch is a protective ground covering such as sawdust, compost, or paper, placed on soil to provide a number of beneficial effects such as reduction of evaporation, maintaining even soil temperature, preventing erosion, and controlling weeds. Mulch is also commonly placed around plants such as trees, shrubs, flowers, and the like to prevent the growth of weeds, preserve moisture in the soil, protect the soil from erosion by wind or rain, and/or to provide a decorative function.

For gardening, landscaping, and the like, the mulches used are typically granular materials that are easily spread to cover selected and often irregular areas. Such materials as wood chips, tree bark, hay, bonded shredded paper, and the like, have been used as mulches. Some mulches are biodegradable, and naturally decompose over time to become part of the soil. In other cases, for example, around the base of trees, in carefully landscaped areas and/or gardens, and in areas where any growth of vegetation is to be totally suppressed, it may be desirable to use a permanent mulch material, such as rocks or gravel. Such mulches provide a relatively permanent area free from the growth of weeds or other plants that would interfere with the growth of the protected plant or the intended visual appearance of a garden or other landscaped area.

However, permanent ground covering mulches are susceptible to being moved and scattered by wind and/or rain unless they are of sufficient size to resist these forces. Consequently, relatively large-sized materials, such as pumice and river rock have been used for permanent mulches, particularly for large exposed areas. These large-sized materials and rocks present certain difficulties in spreading and arranging, and in some locations are aesthetically unacceptable.

Accordingly, a need continues to exist for a permanent ground cover or mulch material that is relatively small in particle size that can resist movement under the effects of wind and rain.

### SUMMARY OF THE INVENTION

One object of the present invention is to provide a self-coherent particulate material of relatively small particle size capable of serving as a permanent ground cover or mulch that can resist movement under the force of wind and/or rain.

A further object of the present invention is to provide a method for protecting the surface of soil by covering it with a layer of self-coherent particulate material of relatively small particle size capable of serving as a permanent ground cover or mulch that can resist movement under the force of wind and/or rain.

Another object of the present invention is to provide a ground-covering layer of self-coherent particulate material of relatively small particle size characterized by a magnetic property and capable of serving as a permanent or mulch with superior resistance against movement under the action of wind and/or rain.

The foregoing and other objects of the invention will become apparent from the description of the invention which follows.

### DETAILED DESCRIPTION OF THE INVENTION AND PREFERRED EMBODIMENTS

In general, the self-coherent particulate material of the invention characterized by magnetic properties comprises magnetic particles having a major dimension that may range in size from about 1 millimeter to about 25 millimeters. The general shape of the particles is not critical, and the particles may have any shape, exemplary of which are narrow cylindrical or needle-shaped particles, plates or platelets of any convenient thickness, or regular or irregular chunks. It is preferred that the particles have roughly equal dimensions in three perpendicular axes, i.e., particles having a rough diameter. These particles are readily obtained by conventional manufacturing processes as discussed below, or by crushing or otherwise comminuting conventional magnetic materials. The particles will have a rough diameter ranging from about 1 millimeter to about 25 millimeters, preferably from about 2 millimeters to about 20 millimeters, and more preferably, from about 6 millimeters to about 13 millimeters.

Any particulate magnetic material can be used; however, preferred materials are ferrites, which are well-known ceramic magnetic materials. A preferred material is strontium ferrite. Other materials such as barium ferrite may also be used. Dispersions of ferrites in binding materials, such as natural or synthetic rubber may also be used. The magnetic attraction between the particles serves to hold the mass of particles together and prevent the particles from being moved or scattered by external forces, e.g., wind and/or rain.

The magnetic material may be used alone or admixed with magnetic attracting material such as iron, a magnetically soft alloy, or magnetite and used as a magnetic protective ground cover or magnetic mulch. The ferrite used may be a magnetized magnetic (magnetically hard) ferrite. Magnetite is available in abundance and is the preferred magnetic attractant.

The blend of magnetically soft alloy material with a ferrite will, in general, not have as forceful a self-attraction as a composition comprising 100% granulated or particulate ferrite; however, such a blend or mixture may be adequate for certain applications, and has evident economic advantages. Typically, the magnetic particles should constitute at least about 50% by volume of the self-coherent particulate magnetic mulch, with the remainder being a particulate magnetic attractive material.

The particulate magnetic material used in the magnetic mulch and method of manufacturing the same may be any conventional method. When ferrite materials are fired in a kiln according to conventional methods of manufacture, the final product is an agglomeration of ferrite crystals, and the size of the material exiting the kiln can be controlled by adjusting the temperatures in the kiln, the time of firing, and other conventional parameters of kiln operation well-known to those skilled in the art. The ferrite material obtained by conventional kiln-firing processes is a random distribution of angular and smooth pellets having a rough diameter of about 12.5 millimeters (one-half inch) or less. These pellets can then be magnetized by conventional procedures in equipment well-known to those skilled in the art.

In use, the magnetic mulch of the invention is applied to the surface of the ground to be protected at a depth sufficient to achieve the specific purpose of the mulch, i.e., suppression of unwanted vegetation, prevention of erosion by wind and/or rain, decoration of a landscape or garden, or the like. Typically, the mulch is applied at a depth ranging from about 5 millimeters (¼ inch) to about 100 millimeters (4 inches), preferably from about ¼ inches to about 3 inches, and more preferably from about ¼ inches to about 2 inches. The skilled practitioner will recognize that the preferred thickness of the protective layer will depend on the severity of the meteorological conditions against which the ground is to be protected and/or the character of the vegetation to be suppressed.

In addition to its protective function, the mulch of the invention may also perform a decorative function. If the mulch is made from agglomerated ferrite crystals, the planar surfaces of the crystal (which will, in general, be randomly oriented within the agglomerate), will reflect light and give a sparkling appearance in sunlight. The amount of the reflection can be controlled by the manufacturing process. Other colored or reflecting particulate material may also be incorporated into the particulate magnetic mulch. The skilled practitioner will understand that incorporation of magnetically inert particulate material into the particulate magnetic mulch may decrease the self-coherency of the magnetic mulch proportional to the amount of magnetically inert particulate material. Accordingly, magnetically inert particulate material should not be incorporated to the extent that the particulate magnetic mulch ceases to be self-coherent and/or perform its intended protective function. Typically, the magnetic particles should constitute at least about 50% by volume of the self-coherent particulate magnetic mulch, with the remainder being particulate magnetically inert material. It is also possible to incorporate decorative magnetically inert particulate material into the mixture of magnetic particulate material and magnetic attractive particulate material disclosed above. In such a mixture the magnetic particulate material should comprise at least about 50% by volume of the mixture.

While the invention has been described with reference to preferred embodiments, it is to be understood that other specific forms or variations may be made without departing from its spirit and scope. Accordingly, the embodiments described above are illustrative only and not restrictive, the scope of the invention being indicated by the appended claims, and all changes which come within the meaning and range of equivalence of the claims are intended to be embraced herein.

We claim:

1. A method for providing a protective ground cover comprising covering a selected area of ground with a layer of a self-coherent particulate magnetic material.

2. The method of claim 1, wherein said layer of self-coherent particulate magnetic material has a thickness sufficient to prevent erosion by wind and/or rain.

3. The method of claim 1, wherein said layer of self-coherent particulate magnetic material has a thickness sufficient to prevent growth of undesired vegetation.

4. The method of claim 1, wherein said self-coherent particulate magnetic material is a ferrite.

5. The method of claim 4, wherein said ferrite is strontium ferrite.

6. The method of claim 1, wherein said self-coherent particulate magnetic material is a mixture of a ferrite and a magnetic attractive material.

7. The method of claim 6, wherein said ferrite is strontium ferrite.

8. The method of claim 6, wherein said magnetic attractive material is magnetite.

9. The method of claim 1, wherein said layer of self-coherent particulate magnetic material has a thickness ranging from about 5 millimeters to about 100 millimeters.

10. The method of claim 1, wherein said layer of self-coherent particulate magnetic material has a thickness ranging from about 5 millimeters to about 75 millimeters.

11. The method of claim 1, wherein said layer of self-coherent particulate magnetic material has a thickness ranging from about 13 millimeters to about 50 millimeters.

12. A self-coherent particulate magnetic material comprising magnetic particles having a diameter of from about 1 millimeter to about 25 millimeters.

13. The self-coherent particulate magnetic material of claim 12 comprising magnetic particles having diameter from about 6 millimeters to about 13 millimeters.

14. A self-coherent particulate magnetic material comprising a mixture of a particulate magnetic material and a particulate magnetic attracting material.

15. The mixture of claim 14, wherein said particulate magnetic material comprises at least about 50% by volume of said mixture.

16. A self-coherent particulate magnetic material comprising a mixture of a particulate magnetic material and a particulate magnetically inert material.

17. The mixture of claim 14, wherein said particulate magnetic material comprises at least about 50% by volume of said mixture.

18. A method for providing a mulch cover comprising covering a selected area of ground with a layer of a self-coherent particulate magnetic material.

19. A mulch comprising a self-coherent particulate magnetic material comprising magnetic particles having a diameter of from about 1 millimeter to about 25 millimeters.

20. A mulch comprising a self-coherent particulate magnetic material comprising a mixture of a particulate magnetic material and a particulate magnetic attracting material.
